(19) United States
(12) Patent Application Publication
(10) Pub. No.: US 2025/0274411 A1
(43) Pub. Date: Aug. 28, 2025

(54) USER AND MODEL REACTIONS WITH LARGE LANGUAGE MODELS

(71) Applicant: OpenAI OpCo, LLC, San Franciso, CA (US)

(72) Inventors: Noah DEUTSCH, San Francisco, CA (US); Benjamin ZWEIG, San Francisco, CA (US); Jotham TAYLOR, III, San Francisco, CA (US); Joanne JANG, San Francisco, CA (US)

(73) Assignee: OpenAI OpCo, LLC, San Francisco, CA (US)

(21) Appl. No.: 19/064,553

(22) Filed: Feb. 26, 2025

Related U.S. Application Data
(60) Provisional application No. 63/558,470, filed on Feb. 27, 2024.

(51) Int. Cl. H04L 51/04; G06F 40/30

(52) U.S. Cl. CPC H04L 51/04; G06F 40/30

(57) ABSTRACT

Disclosed herein are methods, systems, and computer-readable media for interacting with a language model using model or user reactions. When a system receives a user message though a user interface, the system may evaluate the user message (e.g., the message emotion or formality) to generate an input for the language model for generating a response with a reaction token (e.g., a heart, thumbs up, or smiley face). In response to the input generated, the system can generate a response comprising a reaction token, and the system can be configured to render the reaction token in the user interface as a model reaction to the user message. Reactions tokens can be used for collecting user feedback on model responses to fine-tune and retrain language models.

### CROSS-REFERENCE TO RELATED APPLICATIONS

This application claims priority under 35 U.S.C. § 119 to U.S. Provisional Application No. 63/558,470, filed on Feb. 27, 2024. The disclosures of the above-referenced application are expressly incorporated herein by reference in its entirety.

### FIELD OF DISCLOSURE

The disclosed systems and methods generally relate to systems, devices, methods, and computer readable media for interacting with language models. More specifically, and without limitation, this disclosure relates to interaction with language models using user or model reactions, the reactions can then be used to provide feedback to the model.

### BACKGROUND

Language models (LMs) are deep learning algorithms that can perform a variety of natural language processing (NLP) tasks. Some LMs use transformer models and are trained using large datasets. This enables LMs to recognize, translate, predict, or generate text or other content. Language models are also referred to as neural networks (NNs), which are computing systems inspired by the human brain. These neural networks work using a network of nodes that are layered, much like neurons.

### SUMMARY

The disclosed systems and methods provide technical improvements that address technical problems arising in the context of interacting with LMs using user and model reactions. Disclosed systems utilize processors and storage devices equipped to handle operations ranging from the reception and processing of user messages to the generation of inputs for language models. These inputs include optional reaction tokens, which add a layer of interactivity to user and model responses.

Traditional LM interactions can be limited in scope due to operating within a relatively narrow interaction framework. Traditional LMs are primarily designed to respond to direct inputs with corresponding outputs, following a linear transactional model of communication. This approach, while functional, does not fully capture the intricacies of the dynamic nature of human communication. As a result, such systems often fall short in providing an engaging and interactive user experience. LMs, while capable of processing natural language and performing certain useful functions, have some limitations. For example, LMs often rely on user feedback for training, improving responses, and/or to generate datasets. However, LM developers often lack efficient and engaging user feedback mechanisms. User feedback can be complicated to obtain or can be received in multiple formats or in poor quality. Without appropriate user feedback, LMs have a limited ability to efficiently receive and process user feedback. And such limitations hinder the iterative improvement of LMs. Furthermore, LMs cannot have access to more comprehensive and nuanced training datasets, therefore reducing the overall quality of training data.

Additionally, LMs can be unable to effectively incorporate cues, such as emotional or contextual cues, in processing inputs for generating responses. For example, LMs can have difficulty in efficiently capturing sentiment or mood in an input to generate a response. Consequently, certain LMs cannot be able to have personalized or dynamic interactions with users and can be unable to adapt to user preferences, sentiment, or reactions, or such interactions may require multiple prompts with users and/or large computational expenditure.

The disclosed systems, apparatus, devices, and methods are directed to overcoming these and other drawbacks of existing systems. The present disclosure addresses the problems associated with interactions with language models using user and model reactions during interactions and provides solutions for improving the accuracy, efficiency, trainability, and generation of language model responses based on user reactions.

Disclosed systems and methods include a variety or set of optional reaction tokens including, for example, a thumbs up, a heart, a laugh, an exclamation, a question mark, or any other expressive elements or tokens that serve as a mechanism for users or the LM to provide feedback, convey emotions, or guide the behavior of the LM. The optional tokens can consist of dynamically adjusting expressive elements based on real-time sentiment analysis of the user message or response. Upon receiving an optional reaction token from the user, the system can initiate a model call to assess whether the language model should respond or await further messages from the user.

In systems and methods of this disclosure a system call can prompt a LM to analyze and extract features from the user message, the model responses, and/or the user reaction token. The LM can also be configured to use the extracted features as input into a binary classifier. Features can include information on the sentiment expressed in the user message or reaction token, contextual cues within the user message, user intent based on the content of the message and the provided reaction token, model response tone, appropriateness or relevance, reaction token type, or emotional cues in the user message or reaction token. The prediction made by the binary classification system determines the immediacy of the language model's response.

Additionally, or alternatively, in response to receiving a user reaction token, the system can also review historical user interactions with the model to determine a response from the language model or lack thereof. Reviewing historical user interactions can include reviewing past messages, responses, and reactions to establish context and consider the historical user interactions to allow the model to adapt its responses based on the user's conversational history, providing a more personalized and contextually relevant experience. This adaptation also helps to improve the model's understanding of user preferences, nuances, and evolving dynamics over time.

Additionally, or alternatively, the model call can prompt the LM to further assess, and include as input for the binary classifier, any user preferences stored in the user profile associated with the user message. User preferences can include, for example, “do not respond after a heart” or “never use optional reaction tokens.”

Disclosed systems and methods also improve user-LM interactions by allowing the LM to generate optional reaction tokens in response to user messages. In generating model reactions, the system can generate a model reaction based on specialized instructions. Specialized instructions can dictate the generation of an optional reaction token that corresponds with emotional cues, contextual instructions, or user directions in a user message. Additionally, or alternatively, specialized instruction can dictate the generation of an optional reaction token based on user preferences or conditions received through the user profile associated with the user message. Additionally, or alternatively, the system can generate a response without a model reaction token where the user message lacks any emotional cues, contextual instructions, or user directions in a user message.

Additionally, or alternatively, in response to receiving a user message, the language model can extract any semantics, context, and/or emotional cues exhibited in a user message. The model can then, without any specialized instructions, identify and generate a reaction token based on the semantics, context, and/or emotions in the user message. Alternatively, the system can generate a response where the language model receives a user reaction token with a negative sentiment.

Generating optional reaction tokens can include outputting metadata in a specific format based on the user message and/or the specialized instructions. The generated reaction token can also be rendered in the user interface as a model reaction to the user's message.

The disclosed systems and methods can leverage the optional reaction tokens to facilitate faster feedback from users with lower bandwidth requirements and faster processing during. By using simple and intuitive reaction tokens, users can quickly provide feedback on the language model's responses. This streamlined feedback mechanism can reduce the time and effort required for users to convey their sentiments, making the interaction more efficient. Additionally, the use of reaction tokens minimizes the amount of data transmitted over the network, as these tokens may require less bandwidth compared to lengthy text-based feedback. This reduction in data transmission not only speeds up the feedback process but also enhances the overall responsiveness of the system.

Furthermore, the integration of reaction tokens into user interactions with LMs can improve the overall user experience. The ability to quickly and easily provide feedback through expressive tokens, such as thumbs up, hearts, or laugh emojis, makes the interaction more engaging and enjoyable for users. These tokens also enable the language model to better understand and adapt to user preferences and emotions, leading to more personalized and contextually relevant responses. By incorporating real-time sentiment analysis and dynamically adjusting the model's behavior based on user reactions, the disclosed systems and methods create a more interactive and satisfying user experience. This enhanced interactivity not only fosters a stronger connection between users and the language model but also contributes to the continuous improvement of the model's performance.

The disclosed systems and methods also receive fine-tuning instructions and specialized datasets to improve responsiveness to user reactions. Such datasets can include examples of when the language model should respond immediately or await further messages from the users. Other datasets can include guidelines for the model to interpret and respond to user messages or user reactions, considering timing, sentiment, user engagement patterns, and/or contextual sensitivity.

Disclosed systems and methods further include collecting user feedback based on the user reaction tokens and assessing the language model's performance based on model and user reaction tokens. The disclosed system can also incorporate the user feedback into a training dataset and further train the language model with the dataset. The disclosed system can additionally utilize reinforcement learning techniques to train the language model to generate more relevant responses to the user.

Other systems, methods, and computer networking apparatuses are also discussed within this disclosure.

### BRIEF DESCRIPTION OF THE DRAWINGS

The accompanying drawings, which are incorporated in and constitute a part of this specification, illustrate several systems and methods, and together with the description, serve to explain the disclosed principles. In the drawings:

FIG. 1 is a block diagram illustrating an exemplary machine learning platform for implementing various aspects of this disclosure, according to some of the disclosed systems and methods.

FIG. 2 depicts a flowchart illustrating an exemplary process for interacting with a language model using model reactions.

FIG. 3 depicts a flowchart illustrating an exemplary process for interacting with a language model using model reactions.

FIG. 4 depicts a flowchart illustrating an exemplary process for interacting with a language model using user reactions.

FIG. 5 depicts a flowchart illustrating an exemplary process for providing model reactions using a language model.

FIG. 6 depicts a flowchart illustrating an exemplary process for training language models using user reactions.

FIG. 7 depicts an exemplary model reaction, consistent with disclosed systems and methods.

FIG. 8 is a block diagram illustrating an exemplary operating environment for implementing various aspects of this disclosure, according to some of the disclosed systems and methods.

### DETAILED DESCRIPTION

Exemplary systems and methods are described with reference to the accompanying drawings. In the figures, the left-most digit(s) of a reference number identifies the figure in which the reference number first appears. Wherever convenient, the same reference numbers are used throughout the drawings to refer to the same or like parts. In the following detailed description, numerous specific details are set forth in order to provide a thorough understanding of the disclosed example systems and methods. However, it will be understood by those skilled in the art that the principles of the example systems and methods can be practiced without every specific detail. Well-known methods, procedures, and components have not been described in detail so as not to obscure the principles of the example systems and methods. Unless explicitly stated, the example methods and processes described herein are neither constrained to a particular order or sequence nor constrained to a particular system configuration. Additionally, some of the described systems and methods or elements thereof can occur or be performed (e.g., executed) simultaneously, at the same point in time, or concurrently. Reference will now be made in detail to the disclosed systems and methods, examples of which are illustrated in the accompanying drawings.

It is to be understood that both the foregoing general description and the following detailed description are exemplary and explanatory only and are not restrictive of this disclosure. The accompanying drawings, which are incorporated in and constitute a part of this specification, illustrate several exemplary systems and methods and together with the description, serve to outline principles of the exemplary systems and methods.

A significant limitation in conventional LM interactions includes the absence of dynamic feedback mechanisms. In human communication, feedback is continuous and multi-dimensional, encompassing verbal and non-verbal cues such as tone, emotion, and body language. Traditional LMs however, lack the ability to interpret or generate such nuanced feedback, leading to interaction that may seem mechanical or out of context due to the LMS inability to adapt its responses based on the subtle cues or reactions present in the user's input.

The inability to understand and react appropriately to the nuances of human sentiment and intention is a significant challenge for LMs. Humans often convey meaning through subtle expressions or emotional undertones which is difficult for LMs to detect and accurately interpret. This limitation hinders an LM's ability to engage in meaningful and empathetic dialogues, as it may not grasp the underlying emotions or intentions behind a user's message.

An additional challenge with traditional LMs is their inherent limitation in effectively receiving and utilizing user feedback to enhance their performance. In conventional settings, LMs operate, to a certain degree, in a static mode, where their learning and adaptation are confined to the training data they initially received. This approach significantly limits their ability to evolve based on real-time user interactions. And in instances where feedback mechanisms are limited to either “good response” or “bad response,” such feedback is highly limited in value and interpretation for training purposes. As users interact with LMs, they generate a wealth of data, including corrections, suggestions, and varied expression of satisfaction and dissatisfaction. However, traditional LMs lack the mechanisms to efficiently capture this feedback and incorporate it into their learning processes. LMs are incapable of processing complex feedback or doing so would require highly demanding computational resources. As a result, traditional LMs are unable to dynamically improve their responses to make them more adept at understanding and responding to a broader range of queries and user sentiments.

Collectively, these limitations lead to a reduction in both the efficacy of the LM and the satisfaction of the user. Users may find interaction with LMs to be less engaging, lacking in personalization, and sometimes frustrating if the LM fails to adequately understand or respond to their queries. This can result in a diminished user experience, potentially limit the practical applications of LMs in scenarios requiring more sophisticated, empathetic, or context-aware interactions, and/or minimize feedback from users that interact with LM.

As a solution to the aforementioned technical problems and limitations with traditional LMs, the disclosed systems and methods allow introducing user and model reaction tokens within the user-model interaction framework to enable LMs to interpret and respond to user inputs more effectively, acknowledging the emotional and contextual subtleties of human communication, thereby elevating the interactive experience, and fostering a more intuitive, responsive, and engaging conversation between users and LMs.

Consistent with disclosed systems and methods, user or model reactions can include predefined expressive elements or tokens. Reactions can include a thumbs up, heart, laugh, exclamation, question mark, or other options which serve as a mechanism for users to provide feedback, convey emotions, or guide the behavior of the language model. The model can also respond to user messages by generating its own reaction from the predefined expressive elements or tokens based on instructions and contextual cues. This bidirectional interaction enhances user engagement, facilitates iterative model improvement, and allows for a more personalized and dynamic user experience in NLP applications.

The disclosed systems and methods constitute improvements in the technical field of interacting with language models. User and model reactions can improve the personalization and adaptability of language models' responses to user prompts. Personalized interactions can be based on user preferences, contextual cues, or emotional cues, resulting in a more tailored user experience. The system's consideration of emotional cues, for example, a heart signifying a user's satisfaction with the language model's response or a question mark indicating confusion and eliciting a further response from the model, contributes to improved emotional intelligence in language models. Language models' dynamic adjustment of response strategies based on user reactions adds adaptability to language models, improving the field by allowing language models to respond contextually and enhancing overall system intelligence. Furthermore, the system's versatility in handling various instructions (i.e., user message, model response, user reaction, contextual cues, emotional cues) enhances the model's overall contextual awareness.

The field of user engagement and interaction with language models is improved by enhancing user satisfaction. A user's ability to express reactions and to receive reactions can contribute to a more satisfying user experience, leading to increased user retention and positive perceptions of NLP applications. Reactions can also create a more interactive, engaging, and enjoyable system for users to communicate with language models.

Disclosed systems and methods improve the technical field of model training through iterative model improvement and efficient training data collection. The iterative feedback loop provided by user reactions allows for continuous model refinement, thereby accelerating the improvement of language models through real-time user feedback. Data derived from user reactions facilitates the efficient collection of fine-tuning data, contributing to the creation of more robust and contextually aware language models.

Disclosed systems and methods also improve the efficiency of interacting with language models through the use of reactions as opposed to generating full responses in instances where full responses are unnecessary or redundant. Reacting with predefined tokens involves less computational resources, requiring less computation and making the overall interaction more resource efficient. Transmitting and receiving reactions tokens consumes less bandwidth in comparison to exchanging full sentence responses, leading to lower latency and faster response times. Storing and processing reaction tokens requires less memory compared to handling full sentence responses, thereby promoting a more efficient use of memory. Users expressing their sentiments or reactions quickly through predefined tokens streamlines the interaction and is particularly advantageous for users who prefer a concise way to communicate, avoiding the need to type out complete responses. Similarly, in instances where a full response can be repetitive, reactions offer a concise way to acknowledge or convey sentiments, reducing redundancy in conversations by focusing on essential communication elements.

Illustrative systems and methods are described below.

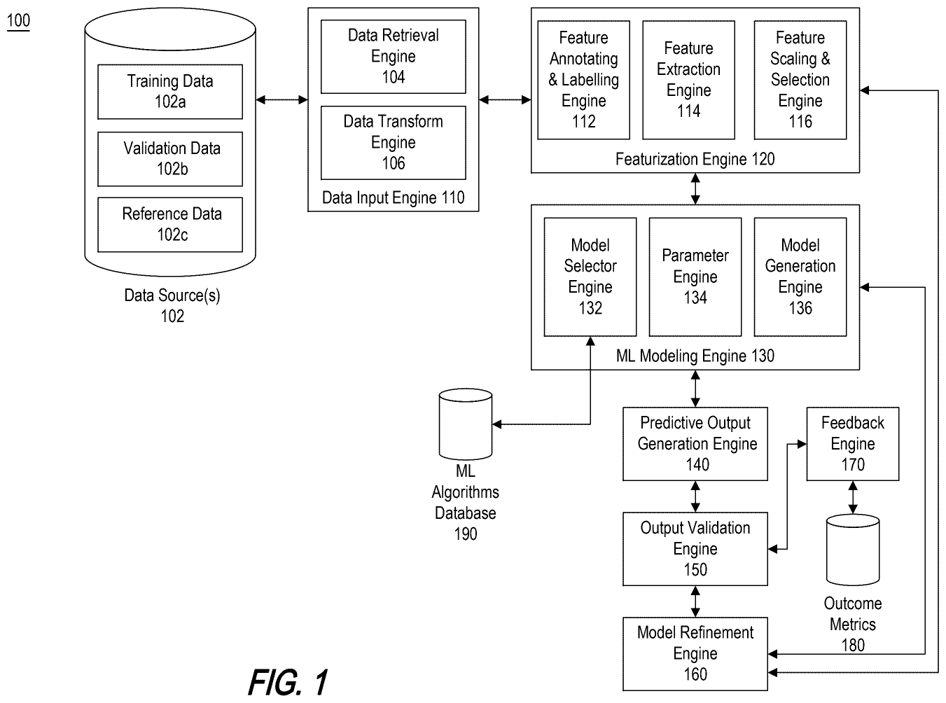

FIG. 1 is a block diagram illustrating an exemplary machine learning platform for implementing various aspects of this disclosure, according to some of the disclosed systems and methods.

System 100 can include data input engine 110 that can further include data retrieval engine 104 and data transform engine 106. Data retrieval engine 104 can be configured to access, interpret, request, or receive data, which can be adjusted, reformatted, or changed (e.g., to be interpretable by other engines, such as data input engine 110). For example, data retrieval engine 104 can request data from a remote source using an API. Data input engine 110 can be configured to access, interpret, request, format, re-format, or receive input data from data source(s) 102. For example, data input engine 110 can be configured to use data transform engine 106 to execute a re-configuration or other change to data, such as a data dimension reduction. In some of the disclosed systems and methods, data source(s) 102 can be associated with a single entity (e.g., organization) or with multiple entities. Data source(s) 102 can include one or more of training data 102a (e.g., input data to feed into a machine learning model as part of one or more training processes), validation data 102b (e.g., data against which at least one processor can compare model output with, such as to determine model output quality), and/or reference data 102c (e.g., ground truth labels used to validate machine learning models). In some of the disclosed systems and methods, data input engine 110 can be implemented using at least one computing device (e.g., computing device 102). For example, data from data source(s) 102 can be obtained through one or more I/O devices and/or network interfaces. Further, the data can be stored (e.g., during execution of one or more operations) in a suitable storage or system memory.

System 100 can include featurization engine 120. Featurization engine 120 can include feature annotating & labeling engine 112 (e.g., configured to annotate or label features from a model or data, which can be extracted by feature extraction engine 114), feature extraction engine 114 (e.g., configured to extract one or more features from a model or data), and/or feature scaling and selection engine 116 (e.g., configured to scale and select features based on certain criteria). Feature scaling and selection engine 116 can be configured to determine, select, limit, constrain, concatenate, or define features (e.g., AI features) for use with AI models. Similar to data input engine 110, featurization engine 120 can be implemented on a computing device.

System 100 can also include machine learning (ML) modeling engine 130, which can be configured to execute one or more operations on a machine learning model (e.g., model training, model re-configuration, model validation, model testing), such as those described in the processes described herein. For example, ML modeling engine 130 can execute an operation to train a machine learning model, such as adding, removing, or modifying a model parameter. Training of a machine learning model can be supervised, semi-supervised, or unsupervised. In some of the disclosed systems and methods, training of a machine learning model can include multiple epochs, or passes of data (e.g., training data 102a) through a machine learning model process (e.g., a training process). In some of the disclosed systems and methods, different epochs can have different degrees of supervision (e.g., supervised, semi-supervised, or unsupervised). Data input to a model to train the model can include input data (e.g., as described above) and/or data previously output from a model (e.g., forming recursive learning feedback). A model parameter can include one or more of a seed value, a model node, a model layer, an algorithm, a function, a model connection (e.g., between other model parameters or between models), a model constraint, or any other digital component influencing the output of a model. A model connection can include or represent a relationship between model parameters and/or models, which can be dependent or interdependent, hierarchical, and/or static or dynamic. The combination and configuration of the model parameters and relationships between model parameters discussed herein are cognitively infeasible for the human mind to maintain or use. Without limiting the disclosed systems and methods in any way, a machine learning model can include millions, billions, or even trillions of model parameters.

ML modeling engine 130 can include model selector engine 132 (e.g., configured to select a model from among a plurality of models, such as based on input data), parameter engine 134 (e.g., configured to add, remove, and/or change one or more parameters of a model), and/or model generation engine 136 (e.g., configured to generate one or more machine learning models, such as according to model input data, model output data, comparison data, and/or validation data). In some of the disclosed systems and methods, model selector engine 132 or model generation engine 136 can be configured to receive input and/or transmit output to ML algorithms database 190. Similarly, featurization engine 120 can utilize storage or system memory for storing data and can utilize one or more I/O devices or network interfaces for transmitting or receiving data. ML algorithms database 190 can store one or more machine learning models, any of which can be fully trained, partially trained, or untrained. A machine learning model can be or include, without limitation, one or more of (e.g., such as in the case of a metamodel) a statistical model, an algorithm, a neural network (NN), a convolutional neural network (CNN), a generative neural network (GNN), a Word2Vec model, a bag of words model, a term frequency-inverse document frequency (tf-idf) model, a transformer model (or other autoregressive model), a Proximal Policy Optimization (PPO) model, a nearest neighbor model (e.g., k nearest neighbor model), a linear regression model, a k-means clustering model, a Q-Learning model, a Temporal Difference (TD) model, a Deep Adversarial Network model, or any other type of model described further herein.

System 100 can further include predictive output generation engine 140, output validation engine 150 (e.g., configured to apply validation data to machine learning model output), feedback engine 170 (e.g., configured to apply feedback from a user and/or machine to a model), and model refinement engine 160 (e.g., configured to update or re-configure a model). In some of the disclosed systems and methods, feedback engine 170 can receive input and/or transmit output (e.g., output from a trained, partially trained, or untrained model) to outcome metrics database 180. Outcome metrics database 180 can be configured to store output from one or more models and can also be configured to associate output with one or more models. In some of the disclosed systems and methods, outcome metrics database 180, or other device (e.g., model refinement engine 160 or feedback engine 170), can be configured to correlate output, detect trends in output data, and/or infer a change to input or model parameters to cause a particular model output or type of model output. In some of the disclosed systems and methods, model refinement engine 160 can receive output from predictive output generation engine 140 or output validation engine 150. In some of the disclosed systems and methods, model refinement engine 160 can transmit the received output to featurization engine 120 or ML modeling engine 130 in one or more iterative cycles.

Any or each engine of system 100 can be a module (e.g., a program module), which can be a packaged functional hardware unit designed for use with other components or a part of a program that performs a particular function (e.g., of related functions). Any or each of these modules can be implemented using a computing device. In some of the disclosed systems and methods, the functionality of system 100 can be split across multiple computing devices to allow for distributed processing of the data, which can improve output speed and reduce computational load on individual devices. In some of the disclosed systems and methods, system 100 can use load-balancing to maintain a stable resource load (e.g., processing load, memory load, or bandwidth load) across multiple computing devices and to reduce the risk of a computing device or connection becoming overloaded. In these or other systems and methods, the different components can communicate over one or more I/O devices and/or network interfaces.

System 100 can be related to different domains or fields of use. Descriptions of systems and methods related to specific domains, such as natural language processing or language modeling, is not intended to limit the disclosed systems and methods to those specific domains, and systems and methods consistent with the present disclosure can apply to any domain that utilizes predictive modeling based on available data.

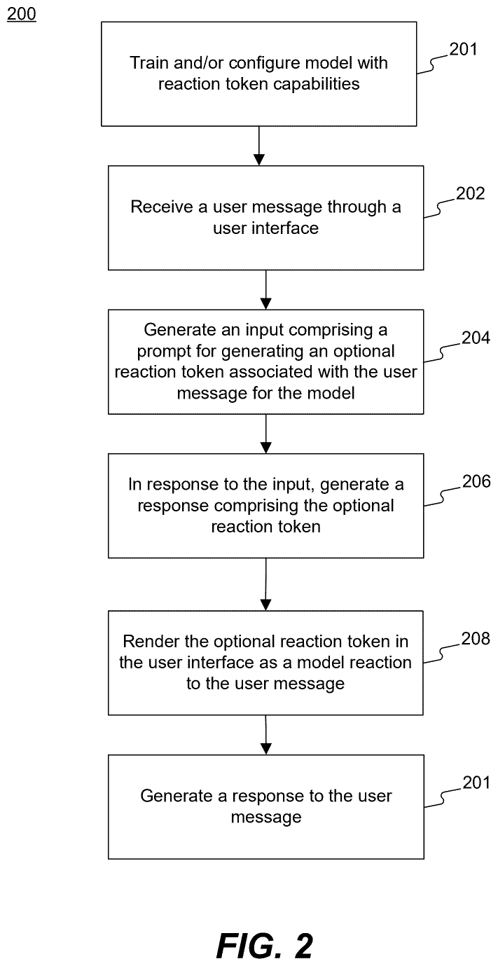

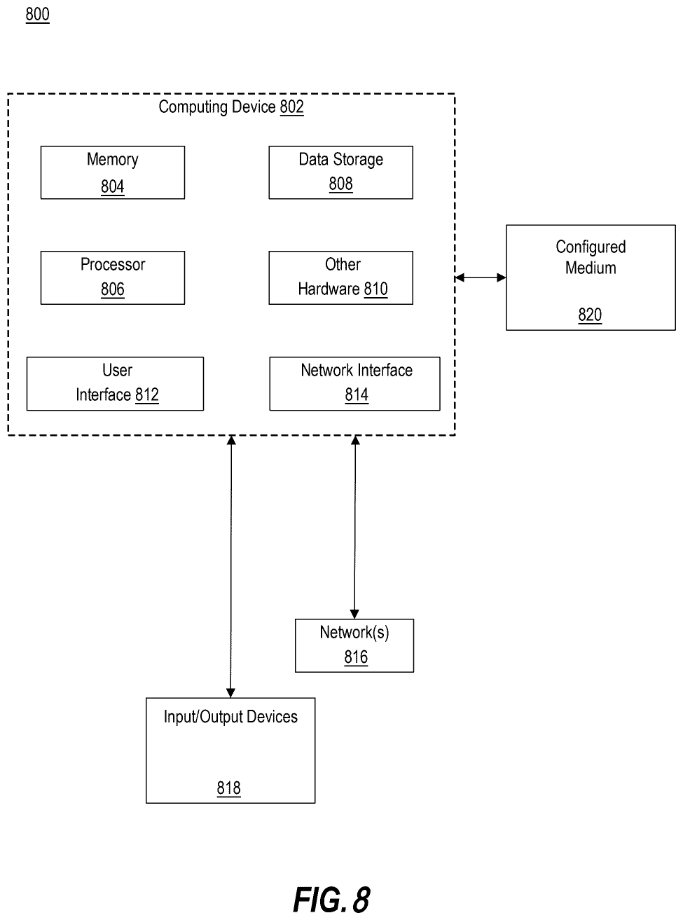

FIG. 2 depicts a flowchart illustrating an exemplary process 200 for interacting with a language model using model reactions, according to some of the disclosed systems and methods. The process shown in FIG. 2 or any of its constituent steps can be implemented using systems in FIG. 1 or 8, or any component thereof. The steps illustrated in FIG. 2 are exemplary, and steps can be added, merged, divided, duplicated, repeated (e.g., as part of a machine learning process), modified, performed sequentially, performed in parallel, and/or deleted in some of the disclosed systems and methods.

Step 201 of method 200 may include training and/or configuration of a language model with reaction token capabilities (e.g., the ability to interpret and respond with reaction tokens). The training of the language model may involve one or more sub-steps for the training of the model.

For example the training and/or configuration of the language model in step 201 may involve data collection and preparation. The data collection can include collecting conversations and texts that include both text and reaction tokens. This data can be collected from social media posts, forums or chat logs, among other sources. In step 201 the data may be vetted to ensure diversity of reaction tokens and their use in different contexts. In step 201 the data may also be processed to facilitate training. For example, the collected data may be filtered by removing elements in the training data that could be confusing or unhelpful during model training. For example, the data may be processed to remove URLs or special characters like ‘#’ or ‘$.’

Step 201 may also involve choosing a base model for training of the language model with reaction token capabilities. For example, step 201 may involve starting with a pre-trained transformer model (e.g., BERT, RoBERTa, among others) that is modified to include reaction token capabilities. For example, the pre-trained model can be modified to include emoji tokens by updating the model vocabulary (e.g., the set of words, subwords, or tokens that the model recognizes and uses to process or generate text) and/or by finetuning the pre-trained model using collected data. Finetuning and/or training in step 201 may also involve performing a training loop with multiple iterations of prediction and true value for training and assessment. In each iteration, the model may calculate the loss (error) between its predictions and the true values, use backpropagation to compute gradients, and updates its parameters using an optimization algorithm like gradient descent to minimize the loss. This process can repeat for multiple epochs until the model's performance converges or meets desired criteria. Step 201 may also involve evaluation and testing. For example, in step 201 the accuracy of the reaction token may be evaluated by determining context appropriateness, and token-to-token patterns. Additionally step 201 may include deployment and optimization. Deployment may include selection of the interface implementation (e.g., via an API or within a graphical user interface). For example, in some embodiments the model may be configured to interpret user messages received through a user interface. Optimization may include pruning of the size model (to improve efficiencies and operations), quantization for faster inference, and caching of frequent reaction token responses. Optimization for the training of the model in step 201 may also involve implementing a response caching, configuring batch processing for multiple requests, and performing load balancing for high-traffic deployment. Further, training in step 201 may include optimization of a tokenization process for the language model with reaction token capabilities. For example, the tokenizer for the language model trained in step 201 may be trained to perform operations like text splitting, while preserving reaction tokens, converting the reaction tokens to special characters, or combination of characters. In some embodiments, the tokenizer may be split in two, one for handling regular text and one for handling reaction tokens for proper handling of reaction tokens. In some embodiments, the tokenizer may be configured to be attached to the user interface.

At step 202, the computer-implemented method can include receiving a user message through a user interface. User messages can be received through a user interface associated with the language model. In some embodiments, user messages may also include non-human messages, such as automated systems, IoT devices, software agents, or robotic process automation (RPA) systems that interact with the language model without direct human input. User messages can include text data in the form of a sentence, a phrase, a paragraph, or any combination of characters. In some of the disclosed systems and methods, user messages can include computer code. Additionally, or alternatively, user messages can include a null set (e.g., having no natural language output). Types of user interfaces that can be used include but are not limited to text-based chat applications, voice-activated interfaces, graphical user interfaces, mobile messaging apps, social media platforms, augmented reality interfaces, virtual reality environments, web-based chat applications, smart assistants, chatbots, and interactive displays. In some of the disclosed systems and methods, the language model can be a natural language processing model, machine learning model, generative model, or a multimodal model.

Referring further to FIG. 2, at 204, the computer-implemented method can also include generating an input comprising a prompt for generating an optional reaction token associated with the user message for the model. Model reaction tokens can include predefined expressive elements or tokens. Reactions include but are not limited to a thumbs up, heart, laugh, exclamation, question mark, or other options which serve as a mechanism for users to provide feedback, convey emotions, or guide the behavior of the language model. Reaction tokens can also dynamically adjust expressive elements based on real-time sentiment analysis of the user message or response.

In generating the input in step 204, the system may perform operations to, based on user message and/or training datasets, generate the input. For example, in step 204 the system may associate the user message to optional reaction tokens based on a context, intensity, formality and/or sentiment analysis. The user message may be mapped to reaction tokens based on emotion, sentiment, or context. For example, if the system determines the context of the user message should be joy, the system may map reaction tokens of [symbol] , [symbol] , [symbol] , [symbol] . Alternatively, if the system determines a response contexts with sadness emotion, the system may map to reaction token such as [symbol] , [symbol] , [symbol] , [symbol] , [symbol] . Other emotions, context, or sentiment could be included (but are not limited to) anger: [symbol] , [symbol] , [symbol] , [symbol] , [symbol] ; surprise: [symbol] , [symbol] , [symbol] , [symbol] ; love: [symbol] , [symbol] , [symbol] , [symbol] ; fear: [symbol] , [symbol] , [symbol] , [symbol] , [symbol] ; and/or neutral: [symbol] , [symbol] , [symbol] , [symbol] , [symbol] . In some embodiments, the language model may generate custom reaction tokens, dynamically generating a unique reaction token, emoji, symbol, or non-textual response based on the sentiment, tone, or contextual meaning of the user's message rather than selected from a predefined set of reaction tokens.

In step 204 the input generation may employ a sentiment analyzer that uses a pretrained model for classification. For example, a small model may be trained to evaluate the user message and prompts to determine one of the sentiments as noted above. The generation of the input in step 204 may also include analyzing the user message content for various features that might influence emoji selection. For example, the system may be configured to determine scores to evaluate and map to the reaction token. The system may be configured to score the sentiment of the message, the intensity of the message, the formality of the message, and/or the length of the message. Based on the captured information, the system may determine a reaction score to identify one or more of the reaction tokens within the reaction token mappings. Alternatively, or additionally, the sentiment determination in step 204 may include determining a sentiment score using a series of pretrained models. For example, a first pretrained model may be configured to determine a negative or positive sentiment. A second pretrained model may be configured to determine an intensity sentiment of acute or dull (e.g., by evaluating punctuation, caps, and emphasis words). And a third pretrained model may be configured to consider sentiment and intensity to map to one or more of the reaction tokens.

The determination of scores in step 204 may allow the system to identify features in the user message to generate the input, select emotion based on features, to generate the input for the language model to produce an appropriate response including a reaction token. Further, generating the input in step 204 may involve generating a structured prompt based on the determined score for the user message. The score may, for example, include an analysis of semantics, context, and emotional cues of the message to determine whether an input request generation of a reaction token should be generated. The input may be created by either a pre-processing module embedded in the user interface, a lightweight model that classifies user messages based on predefined criteria, or a rule-based systems.

Additionally, or alternatively, step 204 may involve the configuration of a model that identifies the emotional tone of the user message, considers the message intensity, identifies and adjust the input for the level of formality in the user message, and generates an input of the language model that would trigger it for generating responses with reaction tokens. This process may involve a message analysis, an emotion mapping that can be specified in the input to the model, and the generation of the input in step 204 with one or more prompts that have detailed context, and relevant message features, and/or suggest appropriate reaction token categories. This model may be configured to be part, or attached to, the interface receiving the user message. But in other embodiments this model may be a secondary model, implemented as part of the large language model (e.g., with a constrained inference or resources), among other implementations.

As an example, if in step 202 a model receives a user message of “I have good news, I got a job today!,” in step 204 the system may generate a generate an input comprising a prompt for generating a reaction token associated with the user message for the model. The system can perform the sentiment, intensity, and formality analysis, generating the score, and identifying mappings for reaction token. Such input could include the user prompt and instructions for reaction token generation, an example input can be;
User message input: “I have good news, I got a job today!”
Generated input: “Generate a response to the user message (I have good news, I got a job today!) including a celebratory professional success emoji, which could then be used to generate an appropriate emoji (like [symbol] or [symbol] or [symbol] ). Use an informal tone and include exclamation marks”

As another example, if in step 202 a model receives a user message of “I am not feeling well today, I am feeling overwhelmed,” in step 204 the system may generate an input comprising a prompt for generating a reaction token associated with the user message using the analyses and scoring discussed previously. The generated input can be, for example;
User message input: “I am not feeling well today, I am feeling overwhelmed”
Added generated input: “Generate a response to the user message (I am not feeling well today, I am feeling overwhelmed) including empathy or support emojis, which could be used to generate a response such as [symbol] [symbol] or [symbol] [symbol] , or do not use exclamation marks”

In some of the disclosed systems and methods, at 206, in response to the input, the model may generate a response comprising the optional reaction token. In some of the disclosed systems and methods, the language model can be prompted to generate an optional reaction token based on received specialized instructions dictating the generation of a reaction token based on cues and analyzing the semantics and context of the user message to identify any cues corresponding to those specified in the specialized instructions. Specialized instructions can also be in the form of user preferences received through the user profile associated with the user message. In some of the disclosed systems and methods, the language model can be prompted to generate an optional reaction token based on received fine-tuning instructions and specialized datasets, the specialized datasets comprising examples of when to generate particular model reactions or to only respond the user message. In some of the disclosed systems and methods, the fine-tuning instructions include guidelines for the model to interpret and respond to user messages or user reactions, considering at least one of timing, sentiment, user engagement patterns, or contextual sensitivity. Timing can inform whether the model should respond immediately or await further messages based on the user reaction token, irrespective of sentiment. Sentiment can inform whether the model should respond immediately or await further messages based on the sentiment associated with the user reaction or whether the model only responds with a particular token based on the sentiment of the user message. User engagement patterns can inform whether the model should respond immediately during high or low user engagement periods. Contextual sensitivity can inform the model what reaction tokens to use based on considering the context of the conversational, such as if it is a more formal or conversational query.

In some of the disclosed systems and methods, generating an optional reaction token comprises outputting metadata in a specific format based on the user message and the specialized instructions, fine-tuning instructions and/or specialized datasets. For example, a model may be configured to generate an optional reaction token with metadata based on the user message, specialized instructions, and fine-tuned datasets. In some embodiments, in addition to finetuning and/or specialized instructions, the model's architecture may be adjusted, adding an output layer to predict both the reaction token and metadata fields alongside regular text generation, using multi-task learning with a custom loss function. As another option, the model may be configured with prompts like “Respond with text and an optional reaction based on sentiment.” And fine-tuning may involve training the model on this dataset with explicit instructions, enabling it to conditionally output reactions when confidence exceeds a threshold, ensuring flexibility and relevance in responses.

In some of the disclosed systems and methods, the computer-implemented method can further include rendering the reaction token in the user interface as a model reaction to the user message 208. Renderings of reaction tokens can include but are not limited to, emojis, icons, symbols, text-based representations, color coding, animated reactions, interactive elements allowing users to tap on reactions for additional actions, integration with message bubbles, customizable rendering by users, overlays or badges, or graphical elements.

In some of the disclosed systems and methods, at 210, the model can generate a response to the user message. Responses to the user message can include text data in the form of a sentence, a phrase, a paragraph, or any combination of characters. In some of the disclosed systems and methods, responses can include computer code. Additionally, or alternatively, responses can include a null set (e.g., having no natural language output). In some of the disclosed systems and methods, responses can be received through a user interface associated with the language model.

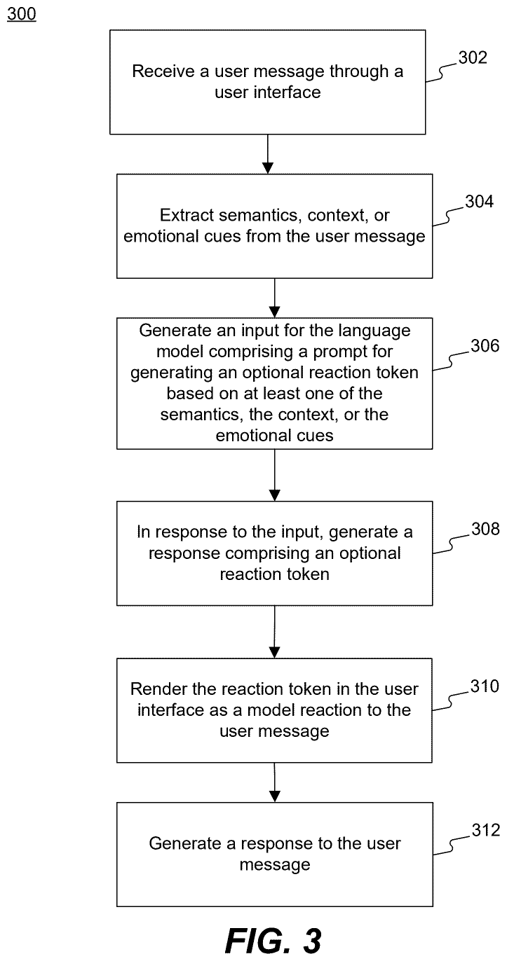

FIG. 3 depicts a flowchart illustrating an exemplary process for interacting with a language model using user reactions, according to some of the disclosed systems and methods. The process shown in FIG. 3 or any of its constituent steps can be implemented using systems in FIG. 1 or 8, or any component thereof. The steps illustrated in FIG. 3 are exemplary, and steps can be added, merged, divided, duplicated, repeated (e.g., as part of a machine learning process), modified, performed sequentially, performed in parallel, and/or deleted in some of the disclosed systems and methods.

In some of the disclosed systems and methods, at 302, the computer-implemented method can include receiving a user message through a user interface. User messages can be received through a user interface associated with the language model. User messages can include text data in the form of a sentence, a phrase, a paragraph, or any combination of characters. In some of the disclosed systems and methods, user messages can include computer code. Additionally, or alternatively, user messages can include a null set (e.g., having no natural language output). Types of user interfaces that can be used include but are not limited to text-based chat applications, voice-activated interfaces, graphical user interfaces, mobile messaging apps, social media platforms, augmented reality interfaces, virtual reality environments, web-based chat applications, smart assistants, chatbots, and interactive displays. In some of the disclosed systems and methods, the language model can be a natural language processing model, machine learning model, generative model, or a multimodal model.

Referring further to FIG. 3, at 304, the computer-implemented method can also include extracting semantics, context, or emotional cues from the user message. Extraction of semantics can be achieved through Natural Language Processing (NLP) techniques including syntax analysis to decipher sentence structure, part-of-speech tagging to understand the role of each word, and dependency parsing to determine relationships between words. Context extraction can include analyzing user messages earlier in the conversation and the user's historical interactions with the model. Emotional cue extraction can be performed by employing algorithms to detect the sentiment or emotional tone of the user's message which can range from simple positive, negative or neutral classifications to more nuanced emotions like happiness, frustration, or surprise. Emotional cues can also be extracted by analyzing specific word choices, phrases, and their intensifiers, as well as, exclamation points, emojis and any other textual features that can provide insight into the user's emotional state.

In some of the disclosed systems and methods, at 306, an input, comprising of a prompt for generating an optional reaction token based on at least one of the semantics, the context or the emotional cues in the user message can be generated for the language model. As further discussed in connection with FIG. 2, the input generated in 306 may be configured at the interface with a model or system that is configured to perform sentiment and emotional tone analysis (e.g., using keywords, punctuation, or a small classifier to determine sentiment or tone), evaluates the message intensity, and assess the formality level, to then score and generate reaction tokens and generate the input to the model. The model reaction tokens can include predefined expressive elements or tokens. Reactions include but are not limited to a thumbs up, heart, laugh, exclamation, question mark, or other options which serve as a mechanism for users to provide feedback, convey emotions, or guide the behavior of the language model. Reaction tokens can also be dynamically adjusting expressive elements based on real-time sentiment analysis of the user message or response. The language model may also generate custom reaction tokens, dynamically generating a unique reaction token, emoji, symbol, or non-textual response based on the sentiment, tone, or contextual meaning of the user's message rather than selected from a predefined set of reaction tokens.

In some of the disclosed systems and methods, at 308, in response to the input, the model may generate a response comprising the optional reaction token. In some of the disclosed systems and methods, the language model can be prompted to generate an optional reaction token based on received specialized instructions dictating the generation of a reaction token based on cues and analyzing the semantics and context of the user message to identify any cues corresponding to those specified in the specialized instructions. Specialized instructions can also be in the form of user preferences received through the user profile associated with the user message. In some of the disclosed systems and methods, the language model can be prompted to generate an optional reaction token based on received fine-tuning instructions and specialized datasets, the specialized datasets comprising examples of when to generate particular model reactions or to only respond the user message. In some of the disclosed systems and methods, generating an optional reaction token comprises outputting metadata in a specific format based on the user message and the specialized instructions, fine-tuning instructions and/or specialized datasets. As further discussed in connection with FIG. 2, for the model to output the model be configured with a specific vocabulary expanded to include reaction token capabilities for the generation of metadata in specific formats. Further, the model may be configured with specific instructions that guide the output generation into a predefined schema. For example, the generation of the reaction token may be explicitly defined in the model input itself (providing reaction token examples). Alternatively, or additionally, fine-tuning the model on examples formatted in the desired structure and, as discussed previously, training on specialized datasets containing labeled reaction tokens with corresponding structured metadata.

In some of the disclosed systems and methods, the computer-implemented method can further include rendering the reaction token in the user interface as a model reaction to the user message 310. Renderings of reaction tokens can include but are not limited to, emojis, icons, symbols, text-based representations, color coding, animated reactions, interactive elements allowing users to tap on reactions for additional actions, integration with message bubbles, customizable rendering by users, overlays or badges, or graphical elements.

In some of the disclosed systems and methods, at 312, the model can generate a response to the user message. Responses to the user message can include text data in the form of a sentence, a phrase, a paragraph, or any combination of characters. In some of the disclosed systems and methods, responses can include computer code. Additionally, or alternatively, responses can include a null set (e.g., having no natural language output). In some of the disclosed systems and methods, responses can be received through a user interface associated with the language model.

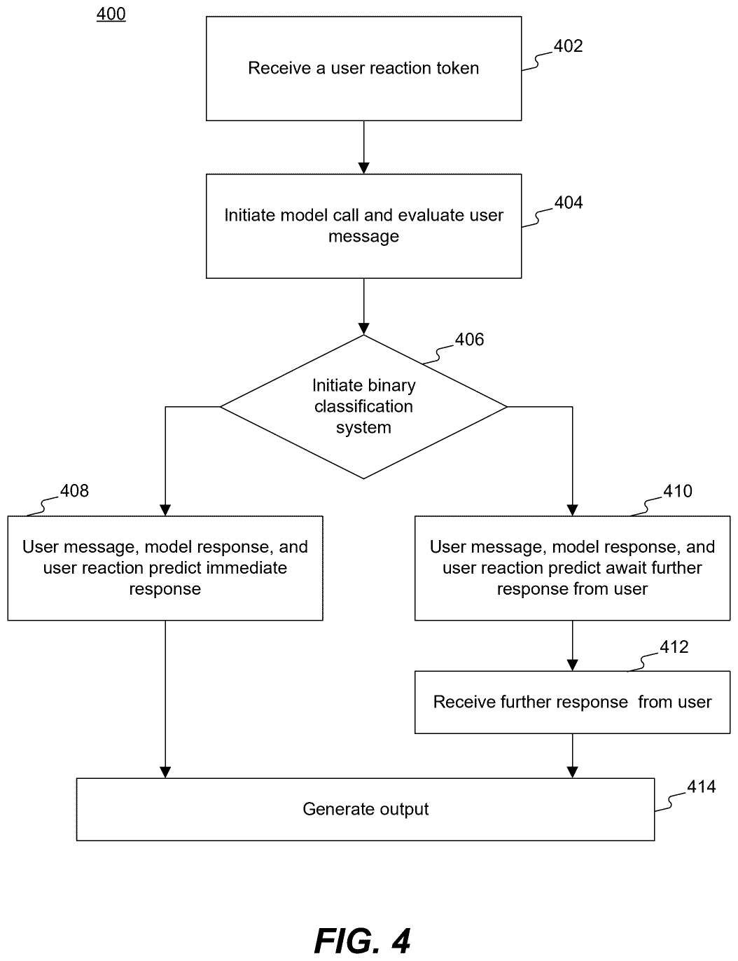

FIG. 4 depicts a flowchart illustrating an exemplary process for interacting with a language model using user reactions, according to some of the disclosed systems and methods. The process shown in FIG. 4 or any of its constituent steps can be implemented using systems in FIG. 1 or 8, or any component thereof. The steps illustrated in FIG. 4 are exemplary, and steps can be added, merged, divided, duplicated, repeated (e.g., as part of a machine learning process), modified, performed sequentially, performed in parallel, and/or deleted in some of the disclosed systems and methods.

In some of the disclosed systems and methods, at 402, the language model can receive a user reaction token. User reaction tokens can be received through users selecting on a specific area or button in the user interface to select a reaction token, an emoji picker or menu, a dropdown menu, voice commands, gesture recognition technology interpreting specific gestures made by users as reaction tokens, text-based commands, reaction bars or panels, drag-and-drop mechanisms where users can drag a reaction token and drop it onto a message or specific area, overlay options, long press, or right click interaction. In some embodiments, the user reaction token may be a reaction to a model response provided to a user's message.

In some of the disclosed systems and methods, the computer-implemented method can also include initiating a model call and evaluating the user message 404. In some of the disclosed systems and methods, the model call can instruct the language model to evaluate the user reaction token associated with the user message. In some of the disclosed systems and methods, the model call can include instructions or parameters that guide the language model in assessing the user's reaction. In some of the disclosed systems and methods, the instructions in the model call can be based on the reaction token, prompting the model to decide whether to generate an optional reaction token in response.

In some of the disclosed systems and methods, the model can initiate a binary classification system 406 in response to the model call providing the user message, model response and user reaction token to the binary classification system.

In some of the disclosed systems and methods, the binary classification system is employed to evaluate the user message, the model response, and the user reaction token to predict whether the model should respond immediately or await further user messages. In some of the disclosed systems and methods, user preferences in the user profile associated with the user message can also serve as input for the binary classification system. In some of the disclosed systems and methods, the system can generate an output 414 depending on a classification decision based on the user message, model response, user reaction, and/or user preferences. In some of the disclosed systems and methods, where the user message, model response, and user reaction cause the binary classification system to predict an immediate response 408, the model will generate an output 414.

In some of the disclosed systems and methods, where the user message model response, and user reaction cause the binary classification system to predict awaiting further user messages 410, the model will not generate an output until the model receives further user messages 412. For example, a user message can state, “I really enjoyed the travel destinations you recommended!” And the model generated response can state, “I′m glad you liked them!” If the user provided a “thumbs up” reaction token to the model's response, the system can predict, using the binary classification system, the model should await further user messages before generating another response.

The binary classification system may be implemented with the language model and/or a model call. For example, the language model can be configured with instructions that have the model determine the binary classification of immediate vs. delayed response when receiving the prompt. Further, the model call can be configured to perform the binary classification. In some situations, the language model or the model call may be configured to have maximum set of resources usage, limiting the amount of interference time or computational resources like memory. Alternatively, or additionally, a specially trained model can be used for the binary classification in determining the prediction of responding immediately or waiting for further user messages. For example, the binary classification can be programmed with a secondary model different from the language model prompted in steps 204 and/or 306. In some implementations the secondary model may be a lightweight classifier designed to quickly determine whether a message requires an immediate response or can wait for more context or further user messages. The lightweight classifier can be configured to analyze the user message against predefined weighted indicators and patterns, without requiring significant computational resources. The lightweight classifier can be configured to evaluate both urgency signals in the user message (like “ASAP”), intensity indicators (further discussed above), and assigning positive and negative weights respectively. Further, the lightweight classifier can also be configured to detect patterns suggesting the need for more context (i.e., await for a response), threshold scoring for urgency and/or intensity. Further, the lightweight classifier can be configured to compute weighted urgency indicators, delay/context patterns.

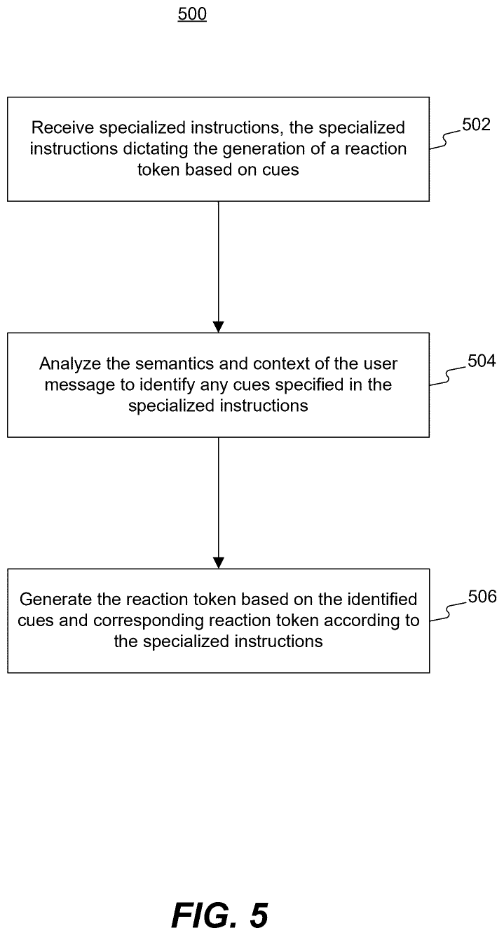

FIG. 5 depicts a flowchart illustrating an exemplary process for generating model reactions using a language model, according to some of the disclosed systems and methods. The steps illustrated in FIG. 5 are exemplary, and steps can be added, merged, divided, duplicated, repeated (e.g., as part of a machine learning process), modified, performed sequentially, performed in parallel, and/or deleted in some of the disclosed systems and methods.

In some of the disclosed systems and methods, the model can be trained to generate reaction tokens by fine-tuning the model. The model can be fine-tuned using at least one of the following processes: collecting diverse training data containing examples of user interactions, messages, and corresponding reactions, annotating the training data with labels indicating appropriate reactions, and/or adjusting parameters, updating datasets, or refining the annotation process to improve the model's ability to generate relevant reactions based on validation testing results.

In some of the disclosed systems and methods, the model can also be trained using prompt engineering, for instance, at 502, the model can receive specialized instructions, the specialized instructions dictating the generation of a reaction token based on cues. In some of the disclosed systems and methods, the specialized instructions can include at least one of, but are not limited to, instructions guiding the model to generate a reaction based on emotional cues in the user's message (i.e., instructing the model to react with a “heart” when the user expresses sadness), instructions specifying reactions for confirming or acknowledging user input (i.e., instructing the model to react with a “thumbs up” to confirm the users statement), instructions tailored to specific prompts or scenarios (i.e., instructing the model to react with a “laugh” when the user shares a joke), instructions related to specific topics or subject matter (i.e., instructing the model to react with a “heart” in response to achievements), instructions guiding the model to react based on agreement or disagreement (i.e., instructing the model to react with a “thumbs down” or a “puzzled emoji” for disagreement), instructions guiding the model to take into account the broader context of the conversation, instructions allowing users to customize the types of reactions they prefer, or instructions providing conditional rules for reactions based on specific conditions (i.e., instructing the model to react with particular tokens if the user's message contains specific keywords or phrases).

In some of the disclosed systems and methods, the specialized instructions can be received as user preferences through the user profile associated with the user message. User preferences can include conditions like “do not respond after a heart” or “never use optional reaction tokens.”

In some of the disclosed systems and methods, the system can analyze the semantics and context of the user message to identify any cues specified in the specialized instructions 504. In some of the disclosed systems and methods, the model can analyze the semantics and context of the user message by parsing the user message and the specialized instructions and compares the contextualized representation of the user message with the cues specified in the specialized instructions to determine how to react based on the provided specialized instructions.

In some of the disclosed systems and methods, at 506, the model can generate the reaction token based on the identified cues and corresponding reaction token according to the specialized instructions. For example, a user message can state, “I aced my exam!” The identified cue can be “positive achievement.” In the specialized instructions, the corresponding reaction to positive achievements can be a “heart” or “smiley face.” Next, the model can generate the reaction token based on the identified cues and corresponding reaction token according to the specialized instructions 506—in this example, a “heart”—and a can further generate a subsequent response to the user message.

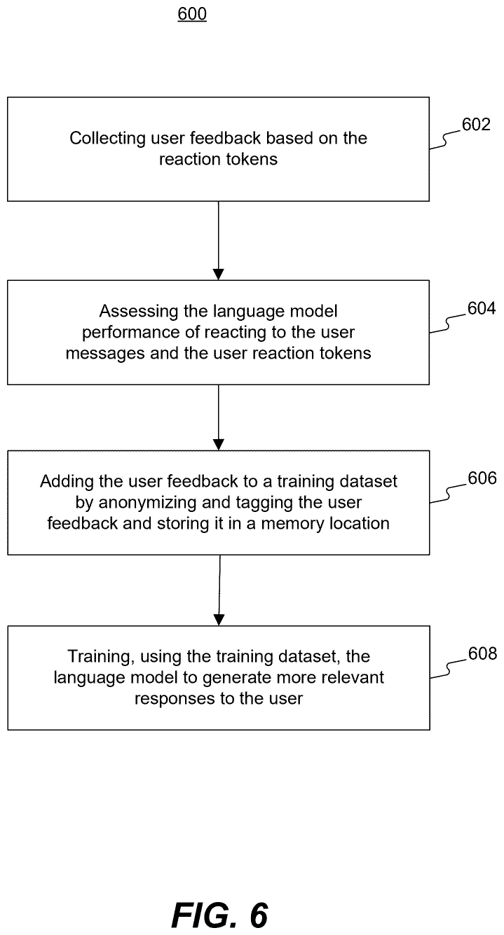

FIG. 6 depicts a flowchart illustrating an exemplary process for training language models using user reactions, according to some of the disclosed systems and methods. The process shown in FIG. 6 or any of its constituent steps can be implemented using systems in FIG. 1 or 8, or any component thereof. The steps illustrated in FIG. 6 are exemplary, and steps can be added, merged, divided, duplicated, repeated (e.g., as part of a machine learning process), modified, performed sequentially, performed in parallel, and/or deleted in some of the disclosed systems and methods.

In some of the disclosed systems and methods, the system can collect user feedback based on the reaction tokens 602. In some of the disclosed systems and methods, collecting user feedback can include event logging where the system can log events each time a user interacts with a reaction token. These logs can include information about the user message, the model's response, the associated reaction token, or any user-specific identifiers. In some of the disclosed systems and methods, a feedback endpoint can be implemented where user interactions with reaction tokens can automatically trigger data submissions, where the endpoint would receive and process feedback data sent by users.

In some of the disclosed systems and methods, at 604, the system can assess the language model's performance of reacting to the user messages and the user reaction tokens. In some of the disclosed systems and methods, the language model's performance can be assessed using at least one of, aggregating the data in broader categories (i.e., instances where users selected the “thumbs down” reaction), assessing whether the reactions are contextually appropriate using relevance metrics, collecting user satisfaction ratings associated with specific reaction tokens, analyzing the frequency of each reaction tokens usage, or comparing the model's generated reactions with user-stated preferences.

In some of the disclosed systems and methods, at 606, the user feedback is added to a training dataset by anonymizing and tagging the user feedback and storing it in a memory location. In some of the disclosed systems and methods, the user feedback is anonymized by sanitizing any personally identifiable information (PII) from the data. Sanitizing can include redacting, tagging, masking, replacing, anonymizing, obfuscating, encrypting, or the like PII in the user feedback. In some of the disclosed systems and methods, the user feedback can be tagged based on categories (i.e., “Relevance,” “Clarity,” “Engagement,” or any aspects related to the model's performance), sentiment analysis providing a score for each piece of feedback (i.e., “Positive,” “Neutral,” or “Negative”), feature-specific tags based on specific features mentioned in the user messages (i.e., “Emotion Recognition” or “Prompt Understanding”), or any custom tags based on the unique goals of the feedback analysis.

In some of the disclosed systems and methods, at 608, the language model is trained using the training dataset to generate more relevant responses to the user. In some of the disclosed systems and methods, the model is trained by updating the model's parameters using a fine-tuning process. In some of the disclosed systems and methods, the fine-tuning process can comprise of placing emphasis on instances where users utilized negative reactions (i.e., thumbs down, question mark, puzzled face emoji, etc.) and adjusting the model's parameters to reduce the likelihood of generating similar responses in the future. In some of the disclosed systems and methods, the training process can include multiple training iterations where the model parameters are updated iteratively to refine its ability to generate more relevant and desirable responses to user messages, desirable messages being those in which users responded to with a positive reaction (i.e., thumbs up, heart, smiley face, etc.). In some of the disclosed systems and methods, the language model is trained using reinforcement learning techniques in addition to the training dataset.

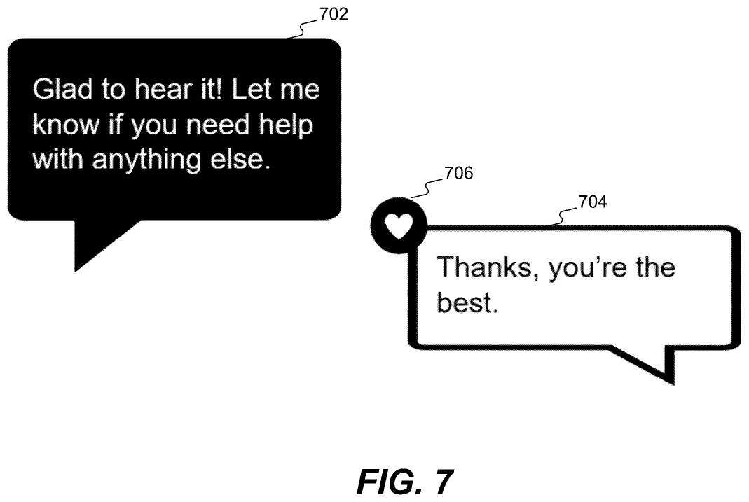

FIG. 7 depicts an exemplary model reaction, consistent with disclosed systems and methods, according to some of the disclosed systems and methods. In some of the disclosed systems and methods, the model can react to an expression of gratitude from a user using the “heart” reaction token. For instance, at 702, a model response reads as follows, “Glad to hear it! Let me know if you need help with anything else.” In response, at 704, the user message states, “Thanks, you're the best.” Following receiving the user message, the model can analyze the semantics and context of the user message to identify any cues in the specialized instruction and generate the reaction token based on the identified cues and corresponding reaction token according to the specialized instructions. In this example, after the model analyzed the user message and compared the identified cue, “expression of gratitude,” with the specialized instructions, the model generated a “heart” reaction token 706. The identified cue here can have also been “a positive sentiment” or “compliment,” instructing the model to render a different reaction token, for example, a “thumbs up” or “smiley face.” Or the model can be given several options for reactions for a specific cue and can render a different reaction for the same cue at different instances. In some of the disclosed systems and methods, following generating a reaction, the model can further respond the user message. In other systems and methods, the model can generate a response without any accompanying reaction tokens where the user message lacks cues as specified in the received specialized instructions or based on the fine-tuning process.

An exemplary operating environment for implementing various aspects of this disclosure is illustrated in FIG. 8. As illustrated in FIG. 8, exemplary operating environment 800 can include computing device 802 (e.g., a general-purpose computing device) in the form of a computer. In some of the disclosed systems and methods, computing device 802 can be associated with a user. Components of computing device 802 can include, but are not limited to, various hardware components, such as one or more processors 806, data storage 808, system memory 804, other hardware 810, and a system bus (not shown) that couples (e.g., communicably couples, physically couples, and/or electrically couples) various system components such that the components can transmit data to and from one another. The system bus can be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

With further reference to FIG. 8, operating environment 800 for an exemplary system includes at least one computing device 802. Computing device 802 can be a uniprocessor or multiprocessor computing device. Operating environment 800 can include one or more computing devices (e.g., multiple computing devices 802) in a given computer system, which can be clustered, part of a local area network (LAN), part of a wide area network (WAN), client-server networked, peer-to-peer networked within a cloud, or otherwise communicably linked. A computer system can include an individual machine or a group of cooperating machines. A given computing device 802 can be configured for end-users, e.g., with applications, for administrators, as a server, as a distributed processing node, as a special-purpose processing device, or otherwise configured to train machine learning models and/or use machine learning models. In some of the disclosed systems and methods, multiple computing devices 802 (e.g., a network of GPUs) can be configured to train a machine learning model.

One or more users can interact with the computer system comprising one or more computing devices 802 by using a display, keyboard, mouse, microphone, touchpad, camera, sensor (e.g., touch sensor) and other input/output devices 818, via typed text, touch, voice, movement, computer vision, gestures, and/or other forms of input/output. Input/output device 818 can be removable (e.g., a connectable mouse or keyboard) or can be an integral part of computing device 802 (e.g., a touchscreen, a built-in microphone). User interface 812 can support interaction between a system or method and one or more users. User interface 812 can include one or more of a command line interface, a graphical user interface (GUI), natural user interface (NUI), voice command interface, and/or other user interface (UI) presentations, which can be presented as distinct options or can be integrated. A user can enter commands and information through a user interface or other input devices such as a tablet, electronic digitizer, a microphone, keyboard, and/or pointing device, commonly referred to as mouse, trackball or touch pad. Other input devices can include a joystick, game pad, satellite dish, scanner, or the like. Additionally, voice inputs, gesture inputs using hands or fingers, or other NUI can also be used with the appropriate input devices, such as a microphone, camera, tablet, touch pad, glove, or other sensor. These and other input devices are often connected to the processing units through an input data interface that is coupled to the system bus, but can be connected by other interface and bus structures, such as a parallel port, game port or a universal serial bus (USB). A monitor or other type of display device is also connected to the system bus via an interface, such as a video interface. The monitor can also be integrated with a touch-screen panel or the like. Note that the monitor and/or touch screen panel can be physically coupled to a housing in which computing device 802 is incorporated, such as in a tablet-type personal computer. In addition, computers such as computing device 802 can also include other peripheral output devices such as speakers and printers, which can be connected through an output peripheral interface or the like.

One or more application programming interface (API) calls can be made between input/output devices 818 and computing device 802, based on input received from user interface 812 and/or from network(s) 816. As used throughout, “based on” can refer to being established or founded upon a use of, changed by, influenced by, caused by, dependent upon, or otherwise derived from. In some of the disclosed systems and methods, an API call can be configured for a particular API, and can be interpreted and/or translated to an API call configured for a different API. As used herein, an API can refer to a defined (e.g., according to an API specification) interface or connection between computers or between computer programs.

System administrators, network administrators, software developers, engineers, and end-users are each a particular type of user. Automated agents, scripts, playback software, and the like acting on behalf of one or more people can also constitute a user. Storage devices and/or networking devices can be considered peripheral equipment in some of the disclosed systems and methods and part of a system comprising one or more computing devices 802 in other systems and methods, depending on their detachability from processor(s) 806. Other computerized devices and/or systems not shown in FIG. 8 can interact in technological ways with computing device 802 or with another system using one or more connections to network 816 via network interface 814, which can include network interface equipment, such as a physical network interface controller (NIC) or a virtual network interface (VIF).

Computing device 802 includes at least one logical processor 806. The at least one logical processor 806 can include circuitry and transistors configured to execute instructions from memory (e.g., memory 804). For example, the at least one logical processor 806 can include one or more central processing units (CPUs), arithmetic logic units (ALUs), Floating Point Units (FPUs), and/or Graphics Processing Units (GPUs). Computing device 802, like other suitable devices, also includes one or more computer-readable storage media, which can include, but are not limited to, memory 804 and data storage 808. In some of the disclosed systems and methods, memory 804 and data storage 808 can be part a single memory component. The one or more computer-readable storage media can be of different physical types. The media can be volatile memory, non-volatile memory, fixed in place media, removable media, magnetic media, optical media, solid-state media, and/or of other types of physical durable storage media (as opposed to merely a propagated signal). In particular, configured medium 620 such as a portable (i.e., external) hard drive, compact disc (CD), Digital Versatile Disc (DVD), memory stick, or other removable non-volatile memory medium can become functionally a technological part of the computer system when inserted or otherwise installed with respect to one or more computing devices 802, making its content accessible for interaction with and use by processor(s) 806. The removable configured medium 820 is an example of a computer-readable storage medium. Some other examples of computer-readable storage media include built-in random access memory (RAM), read-only memory (ROM), hard disks, and other memory storage devices which are not readily removable by users (e.g., memory 804).

Configured medium 820 can be configured with instructions (e.g., binary instructions) that are executable by processor 806; “executable” is used in a broad sense herein to include machine code, interpretable code, bytecode, compiled code, and/or any other code that is configured to run on a machine, including a physical machine or a virtualized computing instance (e.g., a virtual machine or a container). Configured medium 820 can also be configured with data, which is created by, modified by, referenced by, and/or otherwise used for technical effect by execution of the instructions. The instructions and the data can configure the memory or other storage medium in which they reside; such that when that memory or other computer-readable storage medium is a functional part of a given computing device, the instructions and data can also configure that computing device.

Although a system or method can be described as being implemented as software instructions executed by one or more processors in a computing device (e.g., general-purpose computer, server, or cluster), such description is not meant to exhaust all possible systems and methods. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, a system or method can include other hardware logic components 810 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of a system or method can be grouped into interacting functional modules based on their inputs, outputs, and/or their technical effects, for example.

In addition to processor(s) 806, memory 804, data storage 808, and screens/displays, operating environment 800 can also include other hardware 810, such as batteries, buses, power supplies, wired and wireless network interface cards, for instance. The nouns “screen” and “display” are used interchangeably herein. A display can include one or more touch screens, screens responsive to input from a pen or tablet, or screens that operate solely for output. In some systems or methods, other input/output devices 818 such as human input data/output devices (screen, keyboard, mouse, tablet, microphone, speaker, motion sensor, etc.) will be present in operable communication with one or more processors 806 and memory 804.

In some of the disclosed systems and methods, the system includes multiple computing devices 802 connected by network(s) 816. Networking interface equipment can provide access to network(s) 816, using components (which can be part of network interface 814) such as a packet-switched network interface card, a wireless transceiver, or a telephone network interface, for example, which can be present in a given computer system. However, a system or method can also communicate technical data and/or technical instructions through direct memory access, removable non-volatile media, or other information storage-retrieval and/or transmission approaches.

Computing device 802 can operate in a networked or cloud-computing environment using logical connections to one or more remote devices (e.g., using network(s) 816), such as a remote computer (e.g., another computing device 802). The remote computer can include one or more of a personal computer, a server, a router, a network PC, or a peer device or other common network node, and can include any or all of the elements described above relative to the computer. The logical connections can include one or more LANs, WANs, and/or the Internet.

When used in a networked or cloud-computing environment, computing device 802 can be connected to a public or private network through a network interface or adapter. In some of the disclosed systems and methods, a modem or other communication connection device can be used for establishing communications over the network. The modem, which can be internal or external, can be connected to the system bus via a network interface or other appropriate mechanism. A wireless networking component such as one comprising an interface and antenna can be coupled through a suitable device such as an access point or peer computer to a network. In a networked environment, program modules depicted relative to the computer, or portions thereof, can be stored in the remote memory storage device. It can be appreciated that the network connections shown are exemplary and other means of establishing a communications link between the computers can be used.

Computing device 802 typically can include any of a variety of computer-readable media. Computer-readable media can be any available media that can be accessed by the computer and includes both volatile and nonvolatile media, and removable and non-removable media, but excludes propagated signals. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, electrically erasable programmable read-only memory (EEPROM), flash memory or other memory technology, CD-ROM, DVD or other optical disk storage, magnetic cassettes, magnetic tape, magnetic disk storage or other magnetic storage devices, or any other medium which can be used to store the desired information (e.g., program modules, data for a machine learning model, and/or a machine learning model itself) and which can be accessed by the computer. Communication media can embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of the any of the above can also be included within the scope of computer-readable media. Computer-readable media can be embodied as a computer program product, such as software (e.g., including program modules) stored on non-transitory computer-readable storage media.

Data storage 808 or system memory 804 includes computer storage media in the form of volatile and/or nonvolatile memory such as ROM and RAM. A basic input/output system (BIOS), containing the basic routines that help to transfer information between elements within a computer, such as during start-up, can be stored in ROM. RAM can contain data and/or program modules that are immediately accessible to and/or presently being operated on by processing unit. By way of example, and not limitation, data storage holds an operating system, application programs, and other program modules and program data.

Data storage 808 can also include other removable/non-removable, volatile/nonvolatile computer storage media. By way of example only, data storage can be a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

Exemplary disclosed systems and methods include systems, methods, and computer-readable media for the generation of text and/or code embeddings. For example, in some of the disclosed systems and methods, and as illustrated in FIG. 8, operating environment 800 can include at least one computing device 802, the at least one computing device 802 including at least one processor 806, at least one memory 804, at least one data storage 808, and/or any other component discussed above with respect to FIG. 8.

This disclosure can be described in the general context of customized hardware capable of executing customized preloaded instructions such as, e.g., computer-executable instructions for performing program modules. Program modules can include one or more of routines, programs, objects, variables, commands, scripts, functions, applications, components, data structures, and so forth, which can perform particular tasks or implement particular abstract data types. The disclosed systems and methods can also be practiced in distributed computing environments where tasks are performed by remote processing devices that are linked through a communications network. In a distributed computing environment, program modules can be located in local and/or remote computer storage media including memory storage devices.

The systems and methods discussed herein involve or relate to artificial intelligence (AI). AI can involve perceiving, synthesizing, inferring, predicting and/or generating information using computerized tools and techniques (e.g., machine learning). For example, AI systems can use a combination of hardware and software as a foundation for rapidly performing complex operations to perceive, synthesize, infer, predict, and/or generate information. AI systems can use one or more models, which can have a particular configuration (e.g., model parameters and relationships between those parameters, as discussed below). While a model can have an initial configuration, this configuration can change over time as the model learns from input data (e.g., training input data), which allows the model to improve its abilities. For example, a dataset can be input to a model, which can produce an output based on the dataset and the configuration of the model itself. Then, based on additional information (e.g., an additional input dataset, validation data, reference data, feedback data), the model can deduce and automatically electronically implement a change to its configuration that will lead to an improved output.

As used herein, unless specifically stated otherwise, the term “or” encompasses all possible combinations, except where infeasible. For example, if it is stated that a component can include A or B, then, unless specifically stated otherwise or infeasible, the component can include A, or B, or A and B. As a second example, if it is stated that a component can include A, B, or C, then, unless specifically stated otherwise or infeasible, the component can include A, or B, or C, or A and B, or A and C, or B and C, or A and B and C.

Example systems and methods are described above with reference to flowchart illustrations or block diagrams of methods, apparatus (systems) and computer program products. It will be understood that each block of the flowchart illustrations or block diagrams, and combinations of blocks in the flowchart illustrations or block diagrams, can be implemented by computer program product or instructions on a computer program product. These computer program instructions can be provided to a processor of a computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions can also be stored in a computer-readable medium that can direct one or more hardware processors of a computer, other programmable data processing apparatus, or other devices to function in a particular manner, such that the instructions stored in the computer-readable medium form an article of manufacture including instructions that implement the function/act specified in the flowchart or block diagram block or blocks.

The computer program instructions can also be loaded onto a computer, other programmable data processing apparatus, or other devices to cause a series of operational steps to be performed (e.g., executed) on the computer, other programmable apparatus or other devices to produce a computer implemented process such that the instructions that execute on the computer or other programmable apparatus provide processes for implementing the functions/acts specified in the flowchart or block diagram block or blocks.

Any combination of one or more computer-readable medium(s) can be utilized. The computer-readable medium can be a non-transitory computer-readable storage medium. In the context of this document, a computer-readable storage medium can be any tangible medium that can contain or store a program for use by or in connection with an instruction execution system, apparatus, or device.

Program code embodied on a computer-readable medium can be transmitted using any appropriate medium, including but not limited to wireless, wireline, optical fiber cable, RF, IR, etc., or any suitable combination of the foregoing.

Computer program code for carrying out operations, for example, systems and methods can be written in any combination of one or more programming languages, including an object-oriented programming language such as Java, Smalltalk, C++ or the like and conventional procedural programming languages, such as the “C” programming language or similar programming languages. The program code can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a LAN or a WAN, or the connection can be made to an external computer (for example, through the Internet using an Internet Service Provider).

The flowchart and block diagrams in the figures illustrate examples of the architecture, functionality, and operation of possible implementations of systems, methods, and computer program products according to various systems and methods. In this regard, each block in the flowchart or block diagrams can represent a module, segment, or portion of code, which includes one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

It is understood that the described systems and methods are not mutually exclusive, and elements, components, materials, or steps described in connection with one example system or method can be combined with, or eliminated from, other systems and methods in suitable ways to accomplish desired design objectives.

In the foregoing specification, systems and methods have been described with reference to numerous specific details that can vary from implementation to implementation. Certain adaptations and modifications of the described systems and methods can be made. Other systems and methods can be apparent to those skilled in the art from consideration of the specification and practice of the invention disclosed herein. It is intended that the specification and examples be considered as exemplary only. It is also intended that the sequence of steps shown in figures are only for illustrative purposes and are not intended to be limited to any particular sequence of steps. As such, those skilled in the art can appreciate that these steps can be performed in a different order while implementing the same method.

What is claimed is:

1. A system for interacting with a language model, the system comprising:
one or more processors; and
one or more storage devices storing instructions that, when executed, configure the one or more processors to perform operations comprising:
receiving, through a user interface, a user message to a language model;
generating an input for the language model based on the message, the input comprising a prompt for a reaction token associated with the user message;
in response to the input, generating a response comprising the reaction token; and
rendering the reaction token in the user interface as a model reaction to the user message.

2. The system of claim 1, wherein the operations further comprise:
providing, through the user interface, a set of optional reaction tokens for a user to react to the response generated by the language model; and
in response to receiving a user reaction token from the set of optional reaction tokens, determining whether to generate a response immediately or await further user messages.

3. The system of claim 2, wherein determining whether to generate a response immediately or await further user messages comprises:
in response to receiving the user reaction token, initiating a model call, the model call prompting the language model to assess whether to generate an immediate response or await further user messages;
extracting features from the user message, the response, and the user reaction token;
utilizing the extracted features as input for a binary classification system; and
generating an output based on a prediction made by the binary classification system, the prediction being one of respond immediately or await further user messages.

4. The system of claim 3, wherein:
the operations further comprise:
receiving a further user message, the further message being related to the user message, and
generating a response based on the further message; and
the output based on the prediction is generated with a secondary model different from the language model.

5. The system of claim 2, wherein the operations further comprise:
receiving fine-tuning instructions and specialized datasets, the specialized datasets comprising examples of when to respond immediately or await further user messages, to respond to user reactions.

6. The system of claim 2, wherein the operations further comprise:
collecting user feedback based on the user reaction token;
assessing the language model performance of reacting to the user messages and the user reaction token;
adding the user feedback to a training dataset by anonymizing and tagging the user feedback and storing it in a memory location; and
training, using the training dataset, the language model.

7. The system of claim 1, wherein rendering the reaction token comprises rendering of at least one of a thumbs up, a heart, a laugh, an exclamation, a question mark, or an expressive element.

8. The system of claim 1, wherein generating the input for the language comprises:
receiving specialized instructions, the specialized instructions dictating generation of the reaction token based on cues, the cues comprising at least one of emotional cues, contextual instructions, or user directions;
analyzing semantics and context of the user message to identify one or more of the cues specified in the specialized instructions; and
generating the optional reaction token as a model reaction based on the cues and corresponding reaction tokens from a set of optional reaction tokens according to the specialized instructions.

9. The system of claim 8, wherein generating the reaction token comprises outputting metadata in a specific format based on the user message and the specialized instructions.

10. The system of claim 8, wherein the operations further comprise:
before rendering the reaction token in the user interface, determining whether the user message includes the at least one of the emotional cues, the contextual instructions, or the user directions; and
generating a second response without the reaction token when the user message lacks at least one of the at least one of the emotional cues, the contextual instructions, or the user directions.

11. A computer-implemented method for interacting with a language model, the method comprising:
training a language model to generate responses including reaction tokens selected from a set of tokens;
receiving, through an interface, a user message to a language model;
extracting at least one of semantics, context, or emotional cues from the user message;
generating an input for the language model, the input being based on the at least one of semantics, context, or emotional cues in the user message;
in response to the input, generating a response with the language model, the response comprising a reaction token; and
providing the reaction token via the interface as a model reaction to the user message.

12. The method of claim 11, wherein the reaction token comprise dynamically adjusting expressive elements based on real-time sentiment analysis of the user message or response.

13. The method of claim 11, wherein training a language model to generate responses including reaction tokens comprises:
modifying a pre-trained model to include emoji tokens as part of the model vocabulary; and
fine-tuning the pre-trained model using collected data including the emoji tokens.

14. The method of claim 11, further comprising:
generating a response without any accompanying reaction token when determining the set of tokens are unresponsive to the user message.

15. The method of claim 11, further comprising:
providing, through the interface, the set of tokens; and
in response to receiving a user reaction token from the set of tokens, analyzing previous interactions with the language model and determining whether to generate a response immediately or await further user messages.

16. The method of claim 15, wherein determining whether to generate a response immediately or await further user messages comprises:
in response to receiving the user reaction token, assessing user preferences stored in a user profile associated with the user message;
extracting features from the user message, the response, and the user reaction token;
utilize the user preferences and the extracted features as input for a binary classification system token; and
generating an output based on a prediction made by the binary classification system, the prediction being one of respond immediately or await further user messages.

17. The method of claim 15, further comprising:
in response to receiving the user reaction token with a negative sentiment, determining to generate a response immediately.

18. The method of claim 15, further comprising:
receiving specialized datasets and fine-tuning instructions, the fine-tuning instructions comprising guidelines for the model to interpret and respond to reaction tokens based on determined timing, sentiment, user engagement patterns, or contextual sensitivity.

19. The method of claim 15, further comprising:
collecting user feedback based on the user reaction token;
assessing the language model performance based on the user feedback;
adding the user feedback to a training dataset by anonymizing and tagging the user feedback and storing it in a memory location; and
training, using the training dataset and reinforcement learning techniques, the language model to generate more relevant responses.

20. A server deploying a language model, the server comprising:
at least one processor;
a storage location connected to the at least one processor; and
a remote access card connected to the at least one processor and the storage location, wherein the at least one processor is configured to:
receive, through a user interface, a user message to a language model;
prompt the language model to generate a reaction token associated with the user message;
determine, based on the user message, whether to include the reaction token in a response to the user message; and
in response to determining to include the reaction token in the response to the user message, generating the response to the user message including the reaction token; and
rendering the response including the reaction token in the user interface as a model response to the user message.
